(19) United States
(12) Patent Application Publication
(10) Pub. No.: US 2004/0193543 A1
(43) Pub. Date: Sep. 30, 2004

(54) Simultaneous signing of a paper and a digital document

(76) Inventors: Rolf Lennart Nord, Huddinge (SE); Jan Berggren, Lidingo (SE)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/479,302

(22) PCT Filed: May 29, 2002
(86) PCT No.: PCT/SE02/01021

(30) Foreign Application Priority Data
May 29, 2001 (SE) 0101872-0

(51) Int. Cl. G06F 17/60

(52) U.S. Cl. 705/50

(57) ABSTRACT

In a system and a method for a simultaneous, legally binding, signing of a paper document and a digital document (50, 30), the paper and digital documents are provided with a single unique identity. A digital template document (20) is displayed and filled in with document specific data on-line, on the digital screen of a digital interface (10). The filled out digital document (30) is assigned a unique identity and a filled out paper original (50) of the digital document (30is printed (40), provided with the same identity. The digital document (30) is displayed on a connected digitizing means device (60), adapted for receiving a handwritten signature and for digitally reading, transmitting and storing location coordinates of a received signature in a connected database (100). The filled out paper- and digital documents (50, 30) are, via a signature assigning means, simultaneously signed. The signed paper original (90) of the document is verified and manually filed and a digital statutory copy (80) of the signed document is digitally filed in the database (100) as an encrypted image, both sharing a single unique identity for simplified document retrieval. One document signing thus provides a legally valid paper original (90) having a correspondence in the digitally filed document.

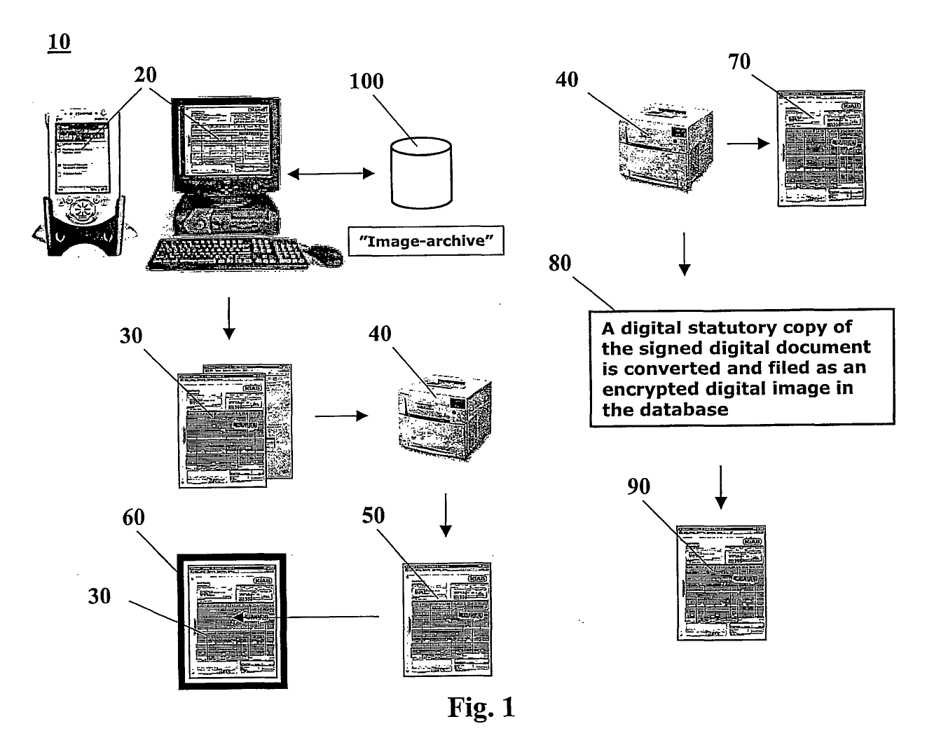

### TECHNICAL FIELD

The present invention pertains to a system and a method for a simultaneous, legally binding, signing of a paper- and a digital document being provided with a single unique identity.

### BACKGROUND ART

When signing contracts, agreements or the like written documents requiring a personal signature, there is often a need for a statutory copy as well as a client copy of the signed paper original. Formerly, all handling of signed contracts and the like written documents where accomplished by hand, which included manually providing and filing statutory copies as well as presenting client copies of the signed paper originals.

The ever present need for authenticity and validity assurance has demanded certain safety measurements to be followed when handling this kind of documents, which often involve matters of economic and/or judicial importance. A signature in ink or the like on a contract paper original has for long been accepted as legally binding and is still among the most acknowledged means of insuring authenticity and legal validity regarding such documents.

Later technology has provided a means for putting a digital signature directly on an electronic document displayed on an electronic clipboard, digitizer or the like electronic device provided with a digital screen. A problem with electronic filing of important documents having digital signatures, are the uncertainties put forth by both contracting parties and computer experts regarding: Who takes full responsibility for what could happen to a digital signature and thus with a drafted contract, agreement or the like if/when e.g. the database crashes, a computer virus or hacker enters the system etc, etc? The answer is that neither operators nor bank corporations/financial institutes or others dare take full responsibility for any such unforeseen events.

Therefore contracting clients or parties nowadays generally still sign important documents by means of a regular pen or the like ink tipped writing device, but since a copy of the actual agreement, contract or the like signed document often is required directly at place and as it also is sought after and convenient to be able to file a digital statutory copy in a database, for the sake of easier document storage and retrieval purposes among other things, the paper original is usually both copied and a scanned after it has been signed properly.

This process of subsequent copying and scanning of signed contracts, agreements, deeds and the like documents as it is usually done today is not only impractical, time-consuming, tedious and unnecessarily costly due to the manual effort incorporated, but it also demands extra equipment to be at hand in the form of e.g. bulky scanning and copying machines, a fact which ads to the inflexibility of the process as a whole.

New technology, for example shown in the document U.S. Pat. No. 6,055,552, by Curry has provided the possibility to actually put down notes on a piece of paper and on a digital screen simultaneously by using a digital electronic clipboard, a piece of paper and a digital pen equipped with a stylus.

The system according to the US document has drawbacks in that it does not present a solution, which allows both inputting data to a computerized device directly e.g. via a keyboard or the like and also via writing on the surface of a connected digital interpreter like a digital electronic clipboard or the like. Their solution is limited to handling digital conversion of handwritten notes only and will not be able to solve the problems e.g. related to digitally providing and presenting forms or documents with input data, which also are to be manually signed.

Hence, there is a need for a system in which a paper original and its digital counterpart is signed simultaneously, at once providing a paper- and digital document having a single unique identity and each being given identical original signatures.

### SUMMARY OF THE DISCLOSED INVENTION

The present invention relates to a system and a method for a simultaneous, legally binding, signing of a paper- and a digital document being provided with a single unique identity, wherein only one signing provides a legally valid paper original of e.g. an agreement, contract or the like having a digital equivalence e.g. for electronic filing, for digital transmission to contracting parties and/or financial- or leasing companies and for printing client copies.

One purpose of the invention is to provide a system and a method for putting down a personal signature on a paper document and on a corresponding digital document at the same time and in the same location on respective document, both documents being provided with the same unique identity thus providing a paper- and digital original of said unique document.

Another purpose of the invention is to provide a system and method for enhanced handling of signed documents such as e.g. written contract, agreements, deeds or the like written documents requiring a personal signature for legal validity allowing shortened lead times in processes dependent on the access of such documents for their continuation.

Yet another purpose of the invention is to provide a system and method, which allows interactivity via networks for data- and telecommunication, like the Internet, e.g. enabling high-speed transmission of digitally signed original contracts and the like documents between different contracting parties and the like participants.

To achieve aims and purposes the present invention provides a system for a simultaneous, legally binding, signing of a paper- and a digital document being provided with a single unique identity. The system comprises:

a digital interface displaying a digital template document on a screen, for on-line filling in with document specific data;

a database, for storing filled in document data;

an open network for data- and telecommunication, for transmitting document data between the interface and the database;

an identity assignment means, for assigning each filled out digital document with a unique identity;

a connection to a printing means, enabling printing of a filled out paper original of said digital document provided with the unique identity;

a digitizing means displaying said filled out digital document, for receiving a handwritten signature and for digitally reading, transmitting and storing location coordinates of a received signature in the database;

a signature assigning means, for the simultaneous signing of the filled out paper- and digital documents provided with identical identities;

a document encrypting means, for image encryption of a statutory copy of the signed digital document; and

whereby the signed paper original of the document is verified and manually filed and the digital statutory copy of the signed document is digitally filed in the database as an encrypted image, both sharing a single unique identity for simplified document retrieval;

whereby one document signing provides a legally valid paper original having a correspondence in the digitally filed document.

In one embodiment of the system according to the present invention, the printed paper original is placed on top and fitting the outlining of the corresponding underlying digital document on the digitizing means, for reception of a handwritten signature on both documents simultaneously.

In another embodiment of the system according to the present invention, the printed paper original has a digitally readable surface on which the position coordinates of a handwritten signature being received thereupon is simultaneously read and transmitted to the corresponding position on the corresponding digital document.

In a further embodiment of the system according to the present invention, a client paper copy of the signed digital document is printed with the unique identity.

In other embodiments of the system according to the present invention, documents are identified with an identification code and the identification code is a barcode, an alphanumerical sequence or the like.

In further embodiments of the system according to the present invention, the digital template document is arranged to be displayed and filled in on the screen of a PC, a handheld computerized device like a pocket PC or PDA or the like digital interface with a screen.

In another embodiment of the system according to the present invention, a number of different types of template documents are stored in the database for selected retrieval of a specific template document type for filling in with document specific data, via an Internet browser or the like.

In further embodiments of the system according to the present invention, filed documents are located and retrieved by using their unique identities and the identities of the two documents to be simultaneously signed are compared for correspondence.

In other embodiments of the system according to the present invention, identification codes are read and compared via an optical reader, the optical reader is provided in the digitising means and the identity assignment means is a random number generator.

In embodiments of the system according to the present invention, the digitizing means is a digitizer, an electronic clipboard or a digital pen additionally equipped with a stylus and an optical reader, for reading the location coordinates of the handwritten signature on a piece of digitally readable paper.

In further embodiments of the system according to the present invention, the signature assignment means is a digital pen, a digital pen additionally equipped with a stylus, a ballpoint pen or the like.

The present invention further sets forth a method for a simultaneous, legally binding, signing of a paper- and a digital document being provided with a single unique identity. The method comprises the steps of.

displaying a digital template document on the screen of a digital interface and filling it in with document specific data on-line;

storing filled in document data in a database;

transmitting document data between the interface and the database through an open network for data- and telecommunication;

assigning a filled out digital document with a unique identity;

printing a filled out paper original of said digital document provided with the unique identity;

displaying said filled out digital document via a digitizing means adapted for receiving a handwritten signature and for digitally reading, transmitting and storing location coordinates of a received signature in the database;

simultaneous signing of the filled out paper- and digital documents provided with identical identities, via a signature assigning means;

image encryption of a statutory copy of the signed digital document; and

whereby the signed paper original of the document is verified and manually filed and the digital statutory copy of the signed document is digitally filed in the database as an encrypted image, both sharing a single unique identity for simplified document retrieval;

whereby one document signing provides a legally valid paper original having a correspondence in the digitally filed document.

In one embodiment of the method according to the present invention, the printed paper original is placed on top and fitting the outlining of the corresponding underlying digital document on the digitizing means, for reception of a handwritten signature on both documents simultaneously.

In another embodiment of the method according to the present invention, the printed paper original has a digitally readable surface on which the position coordinates of a handwritten signature being received thereupon is simultaneously read and transmitted to the corresponding position on the corresponding digital document.

In a further embodiment of the method according to the present invention, a client paper copy of the signed digital document is printed with the unique identity.

In other embodiments of the method according to the present invention, documents are identified with an identification code and the identification code is a barcode, an alphanumerical sequence or the like.

In further embodiments of the method according to the present invention, the digital template document is arranged to be displayed and filled in on the screen of a PC, a handheld computerized device like a pocket PC or PDA or the like digital interface with a screen.

In another embodiment of the method according to the present invention, a number of different types of template documents are stored in the database for selected retrieval of a specific template document type for filling in with document specific data, via an Internet browser or the like.

In other embodiments of the method according to the present invention, filed documents are located and retrieved by using their unique identities and the identities of the two documents to be simultaneously signed are compared for correspondence.

In a further embodiment of the method according to the present invention, the correspondence comparison is accomplished by matching the identification code on the digital document with the identification code optically read from the corresponding paper document.

In other embodiments of the method according to the present invention, the digitizing means comprises an optical reader and the identity assignment is accomplished via a random number generator.

In embodiments of the method according to the present invention, the digitizing of data is accomplished via a digitizer, an electronic clipboard or a digital pen additionally equipped with a stylus and an optical reader, for reading the location coordinates of the handwritten signature on a piece of digitally readable paper.

In further embodiments of the method according to the present invention, the signature assigning is accomplished by means of a digital pen, a digital pen additionally equipped with a stylus, a ballpoint pen or the like.

### BRIEF DESCRIPTION OF THE DRAWINGS

Henceforth reference is had to the attached FIGURE for a better understanding of the present invention and its examples and embodiments, wherein:

The attached single FIGURE illustrates a flowchart describing a flow of events from on-line filling in a template document with document specific data leading to a simultaneously signed paper- and digital original of said document each being provided with the same unique identity, according to one embodiment of the present invention.

### WORDLIST

A handheld computerized device can be a laptop computer, a PDA or the like digital interface provided with a screen and comprising cellular radio equipment or a WAP telephone device etc.

An open network for data communication can be the WWW or other like open networks, Intranets etc.

A PDA (Personal Digital Assistant) is a handheld computer that serves as an organizer for personal information.

### DETAILED DESCRIPTION OF PREFERRED EMBODIMENTS

The present invention relates to a system and a method for a simultaneous, legally binding, signing of a paper- and a digital document being provided with a single unique identity.

The attached single FIGURE, according to one embodiment of the present invention, illustrates a flow of events beginning with an on-line filling in of a digital template document, on the screen of a digital interface, with document specific data leading to a simultaneously signed paper and digital original of the filled in document, each original being provided with the same unique identity and each constituting a legally valid original of the filled in and signed document, which e.g. represents a contract, agreement, lease or the like document between parties requiring a personal signature to be legally binding.

A digital template document 20 e.g. a contract form or the like is either downloaded from a database 100 or directly created on the screen of a handheld or stationary digital interface 10 such as a PC or PDA, for on-line filling in with document specific data e.g. regarding details of a certain agreement, contract, lease, deed or the like. A number of different template document types for e.g. different kinds of contracts, agreements, leases or the like economically/judicially important arrangements can be pre-stored in the database 100, for individual selection and downloading to the screen of the digital interface 10 by a potential client or operator at wish.

Information written on the digital interface 10 is directly stored in the database 100, which can be positioned at a suitable site. Document information can be transmitted between the database 100 and the interface 10, through e.g. a modem or another cable connection or through WAP, bluetooth or the like wireless connection and via e.g. a network for data- and telecommunication such as Intranet, Internet or the like.

A filled in digital document 30 is automatically or manually provided with a unique identity e.g. in the form of a barcode, an alphanumerical sequence or another unique mark placed somewhere on the document before it, via a connection to a printer 40, is printed as a paper original 50 of the filled out digital document 30. The printed paper original 50 of the filled out digital e.g. contract, agreement or the like document requiring a personal signature for legal validity, is thus also provided with the same unique coding as its digital equivalence 30.

The simultaneous signing of the corresponding filled-in paper- and digital original documents can, in one embodiment of the present invention, be accomplished through placing the paper original 50 on top and fitting the outlining of the corresponding underlying digital original 30 being displayed on a digitizing means 60, connected to the computerized device 10. The connection can be accomplished by cable or via a bluetooth, WAP or the like wireless solution. An optical guide (not shown in the FIGURE), e.g. incorporated in the digitizing means 60, can be provided for reading and, through the computerized device 10, enabling comparing, matching, the unique identification codes provided on the paper original 50 and on the respective underlying digital counterpart 30, ensuring that the two originals 30, 50 to be simultaneously signed have the same unique code and that they thus constitute the same document. The optical guide can furthermore scan, read, that the overlying paper original is positioned correctly on the digitizing means, i.e. fitting the outlining of the thereupon displayed digital original, thus ensuring the signature's identical positioning on both originals within a predetermined threshold value.

A simultaneous signing of the two, on top of each other positioned, originals 30, 50 can thereafter be performed manually via a signature assigning means (not shown in the FIGURE) in e.g. ink or the like on the overlying paper original 50 and simultaneously via location coordinate registration of the signature assigning mean's positioning during signing, on the underlying digital original 30 displayed on the screen of the digitizing means 60. The digitizing means 60 can digitally register the positioning of the signature on the underlying digital original through recording or reading e.g. pressure, inductance, radio waves, gyroscopic action or the like, from the signature assigning means. The digitally received signature, i.e. its position on the digital document, is stored in the database 100.

Both document originals, paper 50 and digital 30, are thus provided with an identical signature on identical positions on respective corresponding original, providing a legally valid paper original and a corresponding digital equivalence with only one signing. The digitally signed original can then e.g. be sent with telecom. speed to contracting parties and/or financial- or leasing companies, directly providing a legally valid original e.g. necessary for progressing a economic or judicial process. Client copies 70 of the signed original can also easily be printed 40.

A digital statutory copy 80 of the signed digital document is converted and filed as an encrypted digital image in the database 100 with the identification code linking the filed image to the corresponding signed document originals for easy document retrieval both from the database 100 and from a physical filing place of the signed paper original 90, which is manually filed in a filing cabinet or the like document archive for long term filing of paper originals.

In one embodiment according to the present invention, the digitizing means includes a digital pen additionally equipped with a stylus and an optical reader, for reading the location coordinates of a handwritten signature on a piece of digitally readable paper like e.g. the solution according to the Anoto® paper and digital pen, http://www.anoto.com. The template document is then e.g. directly drafted on- or downloaded from a database to the screen of a digital interface, it is filled in and printed for manual signing following the steps as described above. The signature is thereafter manually put on the digitally readable paper original with the digital pen equipped with a stylus and an optical reader, which registers the position of the signature on the surface of the digitally readable paper and through cable or wireless connection to the digital interface, stores the thus digitized signature with the corresponding digital document original in the database.

The signature assigning means can be a digital pen, a digital pen additionally equipped with a stylus, a ballpoint pen or the like writing device.

A digitizing means 60 can be a digitizer, electronic clipboard or the like digitizing means provided with a screen or a digital pen additionally equipped with an optical reader.

The document encrypting means can be a programming algorithm.

An identity assignment means can be a random-number generator, a bar code generator or the like code generating means.

The optical guide can comprise an optical reader, scanner or the like device for data and/or location coordinate reading from a surface.

Means mentioned in the present description can be software means, hardware means or a combination of both.

The present invention has been described with non-limiting examples and embodiments. It is the attached set of claims that describe possible embodiments for a person skilled in the art.

1-28. (cancelled).

29. A system for a simultaneous, legally binding, signing of a paper document and a digital document being provided with a single unique identity, comprising:
a digital interface displaying a digital template document on a screen for on-line filling in with document specific data;
a database for storing filled in document data;
an open network for data- and telecommunication, for transmitting document data between the interface and the database;
identity assignment means for assigning a filled out digital document a unique identity;
a connection to printing means enabling printing of a filled out paper original of the digital document provided with the unique identity;
digitizing means for displaying the filled out digital document and receiving a handwritten signature and for digitally reading, transmitting and storing location coordinates of a received signature in the database;
signature assigning means for the simultaneous signing of the filled out paper and digital documents provided with identical identities;
document encrypting means for image encryption of a statutory copy of the signed digital document;
wherein the identities of the filled out paper and digital documents to be simultaneously signed are compared for correspondence; and
whereby the signed paper original of the document is verified and manually filed and the digital statutory copy of the signed document is digitally filed in the database as an encrypted image, both sharing a single unique identity for simplified document retrieval; and
whereby one document signing provides a legally valid paper original having a correspondence in the digitally filed document.

30. A system according to claim 29, wherein the digitizing means receives the printed paper original on top and fitting the outlining of the corresponding underlying digital document thereon for reception of a handwritten signature on both the printed paper original and the digital document simultaneously.

31. A system according to claim 29, wherein the printed paper original has a digitally readable surface on which the position coordinates of a handwritten signature being received thereupon is simultaneously read and transmitted to a corresponding position on the corresponding digital document.

32. A system according to claim 29, wherein the printing means enables a client paper copy of the signed digital document to be printed with the unique identity.

33. A system according to claim 29, wherein the unique identity is an identification code.

34. A system according to claim 33, wherein the identification code is a barcode and an alphanumerical sequence.

35. A system according to claim 33, wherein the digitizing means includes an optical reader which reads and compares identification codes.

36. A system according to claim 35, wherein the optical reader is provided in the digitizing means.

37. A system according to claim 29, wherein the digital interface is chosen from the group consisting of a personal computer and a handheld computerized device with the screen arranged to display the digital template document so the digital template document can be filled in to create the filled in digital document.

38. A system according to claim 29, wherein a number of different types of template documents are stored in the database for selected retrieval of a specific template document type for filling in with document specific data via the open network.

39. A system according to claims 29, wherein the database permits the digitally filed signed document to be located and retrieved by using its unique identity.

40. A system according to claim 29, wherein the identity assignment means is a random number generator.

41. A system according to claim 29, wherein the digitizing means is chosen from a group consisting of a digitizer, an electronic clipboard and a digital pen additionally equipped with a stylus and includes an optical reader for reading the location coordinates of the handwritten signature on a piece of digitally readable paper.

42. A system according to claim 29, wherein the signature assignment means is chosen from the group consisting of a digital pen, a digital pen additionally equipped with a stylus, a ballpoint pen and writing means.

43. A method for a simultaneous, legally binding, signing of a paper document and a digital document being provided with a single unique identity, comprising the steps of:
displaying a digital template document on the screen of a digital interface and filling it in with document specific data on-line;
storing filled in document data in a database;
transmitting document data between the interface and the database through an open network for data-and telecommunication;
assigning the filled out digital document a unique identity;
printing a filled out paper original of the filled out digital document including the unique identity;
displaying the filled out digital document via a digitizing means adapted for receiving a handwritten signature and for digitally reading, transmitting and storing location coordinates of a received signature in the database;
comparing the filled out paper original and the filled out digital document to be simultaneously signed for correspondence;
simultaneous signing of the filled out paper original and the filled out digital document via a signature assigning means creating a signed paper original and a signed digital document;
image encrypting a statutory copy of the signed digital document;
verifying and manually filing the signed paper original; and
digitally filing the statutory copy of the signed digital document in the database as an encrypted image;
whereby one document signing provides the signed paper original and the digitally filed statutory copy of the signed digital document with both the signed paper original and the statutory copy of the signed digital document sharing the single unique identity for simplified document retrieval.

44. A method according to claim 43, wherein, during the comparing step, the filled out paper original is placed on top and fitting an outlining of the corresponding filled out digital document on the digitizing means, for reception of a handwritten signature on both documents simultaneously during the signing step.

45. A method according to claim 43, wherein the filled out paper original has a digitally readable surface on which location coordinates of a handwritten signature being received thereupon during the signing step is simultaneously read and transmitted to corresponding location coordinates in the filled out digital document.

46. A method according to claim 43, further comprising the step of printing a client paper copy of the signed digital document having the unique identity.

47. A method according to claim 43, wherein the unique identity is an identification code.

48. A method according to claim 47, wherein the identification code is chosen from the group consisting of a barcode and an alphanumerical sequence.

49. A method according to claim 43, wherein the digital interface is chosen from the group consisting of a personal computer and a handheld computerized device with the screen arranged to display the digital template document so the digital template document can be filled in to create the filled in digital document.

50. A method according to claim 43, wherein a number of different types of template documents are stored in the database for selected retrieval of a specific template document type for filling in with document specific data via the open network.

51. A method according to claim 43, further comprising the step of locating and retrieving the signed paper original and the statutory copy using the unique identity.

52. A method according to claim 43, wherein, during the comparing step, the correspondence is accomplished by matching the identification code on the filled out digital document with the identification code optically read from the filled out paper original.

53. A method according to claim 43, wherein the digitizing means comprises an optical reader.

54. A method according to claim 43, wherein the identity assignment is accomplished via a random number generator.

55. A method according to claim 43, wherein the digitizing means is chosen from the group consisting of a digitizer, an electronic clipboard and a digital pen additionally equipped with a stylus and includes an optical reader for reading the location coordinates of the handwritten signature on a piece of digitally readable paper.

56. A method according to claim 43, wherein the signature assigning means is chosen from the group consisting of a digital pen, a digital pen additionally equipped with a stylus, a ballpoint pen and writing means.
